(19) United States
(12) Patent Application Publication
(10) Pub. No.: US 2010/0112994 A1
(43) Pub. Date: May 6, 2010

(54) HANDS-FREE DEVICE

(75) Inventor: Toshiya TAMURA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 12/607,192

(22) Filed: Oct. 28, 2009

(30) Foreign Application Priority Data
Oct. 31, 2008 (JP) 2008-282340

(51) Int. Cl. H04M 3/42; H04B 7/00

(52) U.S. Cl. 455/415; 455/41.2

(57) ABSTRACT

A hands-free device which is possible to establish a session for hands-free and a session for obtaining phonebook data by short-range wireless communication, obtains phonebook data via the session for obtaining phonebook data and stores the phonebook data. The hands-free device retrieves phonebook data obtained from a device to which the hands-free device is connected by the hands-free session.

### CROSS-REFERENCE TO RELATED APPLICATION

The present invention claims the benefit of priority under 35 USC 119 of Japanese Patent Application No. 2008-282340, filed on Oct. 31, 2008, the entire contents of which are incorporated herein by reference.

### BACKGROUND

1. Technical Field

The present invention relates to a hands-free device.

2. Related Art

A technology has been known which forwards phonebook data between a nearby hands-free device and a wireless communication terminal, using wireless communication. For example, with Bluetooth®, there is the Phone Book Access Profile (PBAP) as a profile for forwarding phonebook data.

According to the PBAP, since a hands-free device can receive and store phonebook data from multiple wireless communication terminals by using PBAP, it is difficult to protect personal information if any wireless communication terminal connected to the hands-free device can access all phonebook data stored in the hands-free device.

For example, Japanese Publication (KOKAI) No. 2008-85466 (Harada) shows a technology to solve the problem described above. In Harada, a control method is described where a mobile phone terminal transfers phonebook data to a hands-free device with information identifying at least one mobile phone terminal which is permitted to access the phonebook data, and the hands-free device restricts access to the phonebook data from mobile phone terminals other than the at least one mobile phone terminal identified by the information.

However, it is conceivable that the phonebook data stored in the hands-free device are displayed on a display screen of the hands-free device. For example, when there is an incoming call to a mobile phone, a hands-free device connected to the mobile phone search stored phonebook data by a telephone number notified of by a calling party, and a name associated with the telephone number is displayed on the display screen. Namely, in the event that the hands-free device retrieves all the stored phonebook data, phonebook data forwarded from a terminal other than the mobile phone currently connected to the hands-free device are displayed on the display screen of the hands-free device.

### SUMMARY

A hands-free device includes: A hands-free device, comprising: a radio interface configured to communicate with an external device via a short-range wireless communication; a hands-free control unit configured to control hands-free connection with an external device by using the radio interface; a phonebook access control unit configured to obtain phonebook data from an external device by using the radio interface; a memory configured to store the phonebook data associated with an identification information of the external device which forwarded the phonebook data; and a controller configured to retrieve stored phonebook data which is associated with identification information of the external device to which the hands-free control unit is connecting.

### BRIEF DESCRIPTION OF THE DRAWINGS

Exemplary embodiments of the present invention will be described in detail based on the following figures, wherein:

FIG. 1 is a diagram showing a relationship between an car kit according to an embodiment of the invention and a mobile phone wirelessly connected thereto;

FIG. 2 is a block diagram showing a configuration of the mobile phone wirelessly connected to the car kit according to the embodiment of the invention;

FIG. 3 is a block diagram showing a configuration of the car kit according to the embodiment of the invention;

FIG. 4 is a flowchart showing a process of establishing a connection for a phonebook forwarding function with a phonebook access control section of the mobile phone wirelessly connected to the car kit according to the embodiment of the invention;

FIG. 5 is a flowchart showing a process of a phonebook access control section of the car kit according to the embodiment of the invention acquiring a phonebook, after the connection for the phonebook forwarding function is established;

FIG. 6 is a hypothetical diagram of phonebook data stored in a phonebook database of the car kit according to the embodiment of the invention;

FIG. 7 is a flowchart showing a process when the phonebook access control section of the car kit according to the embodiment of the invention carries out a retrieval of data from the phonebook data registered in the phonebook database; and

FIG. 8 is a sequence diagram showing a flow of a process when a phonebook forwarding is carried out between the car kit according to the Embodiment of the invention and the mobile phone, and an upper layer application of the car kit issues a request to retrieve the forwarded phonebook data.

### DETAILED DESCRIPTION OF THE INVENTION

Exemplary embodiments of the present invention will be described hereinafter with reference to the accompanying drawings.

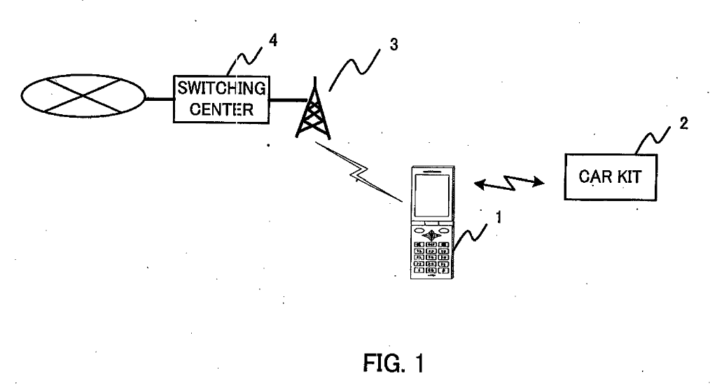

FIG. 1 is a diagram showing a relationship between a mobile phone 1 and a car kit 2 connected each other via short-range wireless communication. The mobile phone 1 transmits and receives information to and from the car kit 2 through the short range wireless link such as Bluetooth® session.

Also, the mobile phone 1 is connectable to a network via a base station 3 and a switching center 4, and carries out voice communication and data communication. Also, the mobile phone 1, including a hands-free control unit for enabling a voice communication between the car kit 2 and the network, forwards information received from the base station 3 to the car kit 2, via the short range wireless link, and transmit information received from the car kit to the base station 3.

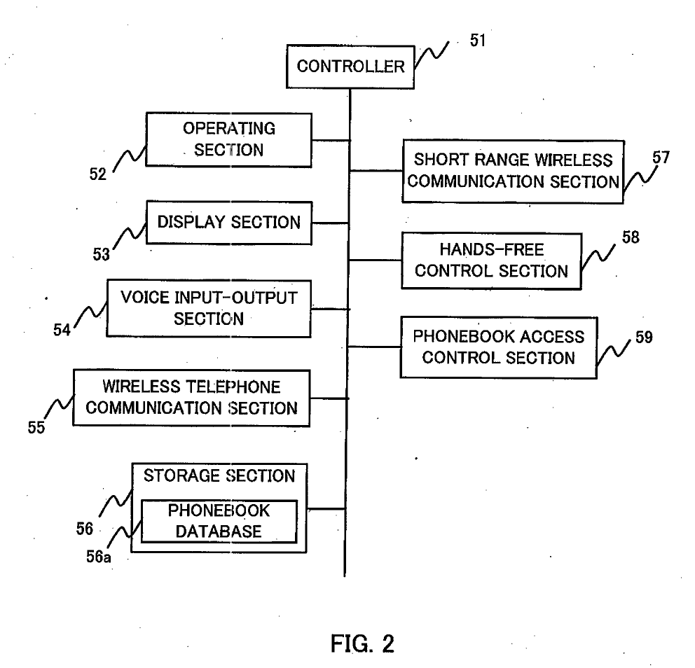

FIG. 2 is a block diagram showing a configuration of the mobile phone 1 according to the embodiment. The mobile phone 1 includes a controller 51, an operating section 52, a display section 53, a voice input-output section 54, a wireless telephone communication section 55, a storage section 56, a short range wireless communication section 57, a hands-free control section 58, and a phonebook access control section 59.

The controller 51, being configured of a CPU, a ROM, a RAM, and the like, carries out a control of the whole of the mobile phone 1.

The operating section 52, being configured of operating keys, a touch pad, a touch panel, or the like, inputs a signal into the controller 51 in accordance with a user's operation.

The display section 53, being configured of a liquid crystal display, an organic EL display, or the like, displays a character and/or image in accordance with a control of the controller 51.

The voice input-output section 54, being configured of a speaker and a microphone, carries out an input and output of a voice communicated by the wireless telephone communication section 55, an output of a voice or music of music content or video content, and the like.

The wireless telephone communication section 55 carries out a voice communication or packet communication via the base station 3. For example, in the event of transmitting a voice by a voice communication, the wireless telephone communication section 55 obtains data by signal processing such as coding and error control to a voice data obtained by the microphone, convert the data into a radio wave, and transmits the radio wave to the base station 3. Also, in the event of receiving a voice, a radio wave is received from the base station 3, a signal processing such as a decoding or an error correction is carried out after converting from the radio wave to an electrical signal, and the voice is output from the speaker of the voice input-output section 54.

The storage section 56 stores various kinds of application software, information registered by the user, and the like. A phonebook database 56a, in which phonebook data are registered, is also included in the storage section 56. A telephone number for telephone communication, and a name, residence address, e-mail address, and the like, associated with the telephone number, are included in the phonebook data.

The short range wireless communication section 57, being configured of a wireless communication module such as a the Bluetooth® module, or the like, which uses a radio wave with less wireless transmission power than that of the wireless telephone communication section 55, carries out a wireless communication with an external device. Hereafter, a description will be given assuming that the short range wireless communication section 57 carries out a connection with an external device via Bluetooth® link. In the event of connecting with an external device via the Bluetooth® link, it is possible to realize a hands-free telephone call using the HFP (Hands-Free Profile), and it is possible to carry out a phonebook forwarding using the PBAP.

The hands-free control section 58 carries out a hands-free control for enabling a hands-free telephone call, with voice communication transmitted and received by the wireless telephone communication section 55, from the car kit 2 via the Bluetooth® session.

The phonebook access control section 59 carries out a control for forwarding the phonebook data registered in the phonebook database 56a to an external device, using the short range wireless communication section 57.

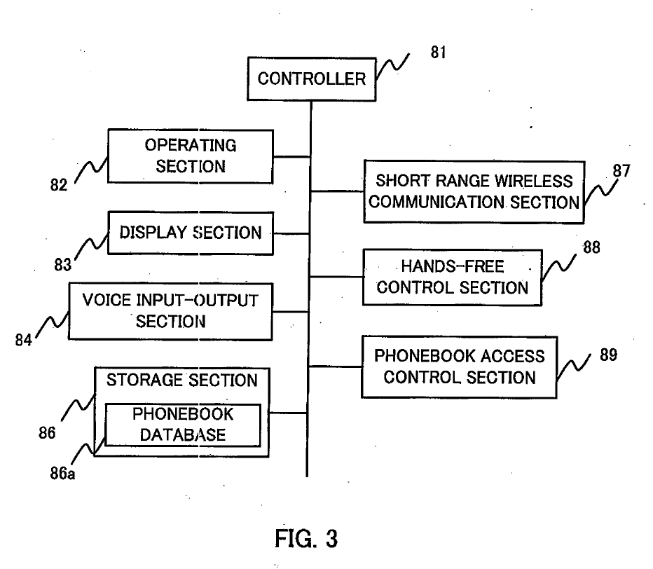

FIG. 3 is a block diagram showing a configuration of the car kit 2 according to the embodiment connectable to the mobile phone 1 via the Bluetooth® session. The car kit 2 includes a controller 81, an operating section 82, a display section 83, a voice input-output section 84, a storage section 86, a short range wireless communication section 87, a hands-free control section 88, and a phonebook access control section 89.

The controller 81, being configured of a CPU, a ROM, a RAM, and the like, carries out a control of the whole of the car kit 2.

The operating section 82, being configured of operating keys, a touch panel, or the like, inputs a signal into the controller 81 in accordance with a user's operation.

The display section 83, being configured of a liquid crystal display, an organic EL display, or the like, displays a character or image in accordance with a control of the controller 81.

The voice input-output section 84, being configured of a speaker and a microphone, carries out an output of a voice or music of music content or video content, and the like.

The storage section 86 stores various kinds of application software, information registered by the user, and the like. A phonebook database 86a, in which are registered phonebook data forwarded from the mobile phone 1 by a process to be described hereafter, is also included in the storage section 86.

The short range wireless communication section 87, being configured of a wireless communication module such as a Bluetooth® module, or the like, which uses a radio wave with low wireless transmission power, carries out a wireless communication with another device.

The hands-free control section 88 controls a hands-free telephone call via the mobile phone 1, using the short range wireless communication section 87, if the mobile phone 1 is connected.

The phonebook access control section 89 controls to acquire the phonebook data from the mobile phone 1, using the short range wireless communication section 87. The phonebook data forwarded from the mobile phone 1 are stored in the phonebook database 86a of the storage section 86. Then, the phonebook data stored in the phonebook database 86a may, for example, be displayed in the display section 83 in accordance with an operation from the operating section 82, or referred to when an incoming voice call is forwarded from the mobile phone 1 by the hands-free control section 88, and then displayed in the display section 83.

A description will be given of a process when the phonebook forwarding is carried out between the mobile phone 1 and car kit 2. When the phonebook forwarding from the mobile phone 1 to the car kit 2 is carried out in accordance with the BPAP, firstly, the Bluetooth® session for a phonebook forwarding function is established between the mobile phone 1 and car kit 2. In order to establish the Bluetooth® session for phonebook forwarding, it is necessary for the mobile phone 1, which is the phonebook forwarding source, to carry out an authentication of the car kit 2, which is the phonebook forwarding destination.

An authentication is carried out between the mobile phone 1 and car kit 2 for a hands-free connection, too. When carrying out a authentication with a hands-free device, the mobile phone 1 searches peripheral hands-free devices, selects a hands-free device to be registered from the searched hands-free devices and, as well as confirming a service with which the hands-free device is compliant, exchanges PINs and carries out an authentication process. When the hands-free device authentication is completed, attribution information, such as a device name and an authentication key, of the registered hands-free device is stored in the storage section 56 of the mobile phone 1, and it is possible to establish the Bluetooth® session for the hands-free function. Carrying out this kind of authentication not only for the hands-free connection, but also for the phonebook forwarding session establishment, is troublesome for the user. Therefore, a case can be considered such that, when establishing the session for the phonebook forwarding function, the authentication process for the phonebook forwarding function is simplified, while still preserving security. For example, it is acceptable that the phonebook access control section 59 of the mobile phone 1 controls in such a way as to establish the session for the phonebook forwarding function in the event that it is possible to confirm that a phonebook forwarding request is from a hands-free device which is authenticated for carrying out a hands-free connection via the Bluetooth® session.

Also, for example, the hands-free control section 58 of the mobile phone 1 needing an authentication for the hands-free connection, it is acceptable that the phonebook access control section 59 of the mobile phone 1 controls in such a way as to establish the session for the phonebook forwarding function in the event that it is possible to confirm that a phonebook forwarding request: is from a hands-free device which is in hands-free connection via the Bluetooth® session. Hereafter, as an example, a description will be given of a case of establishing the session for the phonebook forwarding depending on whether or not a phonebook forwarding request is from a hands-free device which is in hands-free connection in this way.

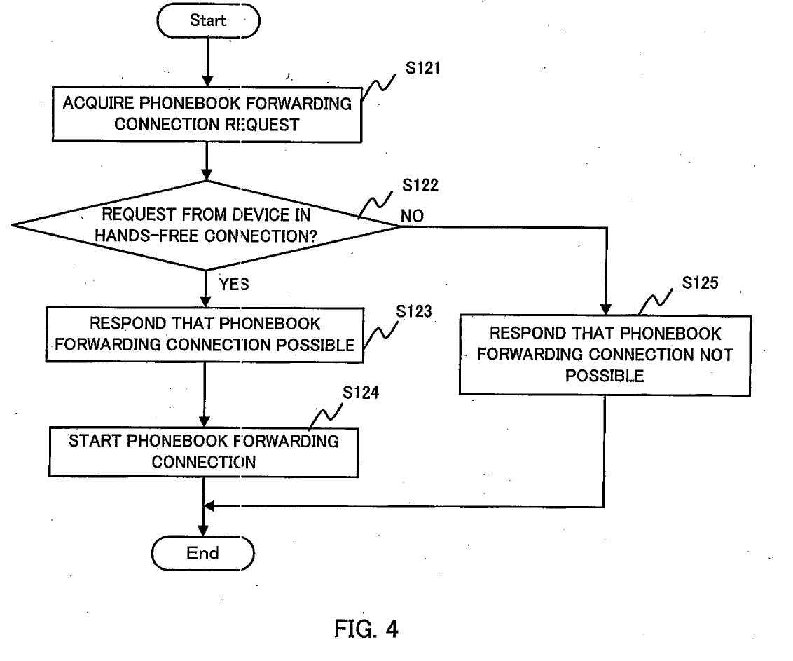

FIG. 4 is a flowchart showing a process of establishing a connection for the phonebook forwarding function with the phonebook access control section 59 of the mobile phone 1. Firstly, the phonebook access control section 59 acquires a request for establishing phonebook forwarding session received from a hands-free device by the short range wireless communication section 57 (S121). Then, the phonebook access control section 59, using information included in the request identifying the hands-free device, determines whether or not it is a request transmitted from a device in a hands-free connection (S122) and, if it is a phonebook forwarding connection request transmitted from the hands-free device which is connected by a hands-free connection (Yes in S122), responds to the hands-free device informing that a phonebook forwarding session is possible (S123), and starts the phonebook forwarding session (S124). Meanwhile, if it is a phonebook forwarding session request transmitted from a device other than one in a hands-free connection (S122: No), the phonebook access control section 59 responds to the hands-free device to the effect that a phonebook forwarding session is not possible (S125).

Meanwhile, in the event that the phonebook access control section 89 of the car kit 2, after outputting a request to establish a phonebook forwarding session, receives a response indicating that the phonebook forwarding connection is possible, the phonebook access control section 89 establishes the phonebook forwarding session.

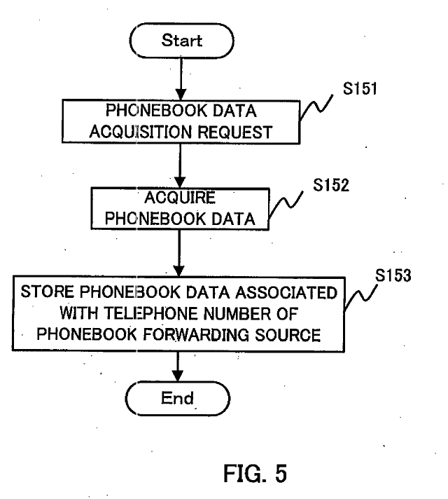

FIG. 5 is a flowchart showing a process of the phonebook access control section 89 of the car kit 2 acquiring a phonebook after the phonebook forwarding session is established. The phonebook access control section 89, after the phonebook forwarding session is established, outputs a request for acquiring the phonebook data to the mobile phone 1 (S151). Then, as well as acquiring the phonebook data from the mobile phone 1 (S152), the phonebook access control section 89 acquires mobile phone 1 identification information from the hands-free control section 88, which carries out the hands-free connection with the mobile phone 1. Then, the phonebook access control section 89 stores the phonebook data in the phonebook database 86a of the storage section 86, associated with the identification information of the mobile phone 1 (S153). The mobile phone 1 identification information, being information which uniquely identifies the mobile phone 1, is, for example, a telephone number. Hereafter, a description will be given assuming that the phonebook data, and the telephone number of the mobile phone 1 which is the forwarding source thereof, are stored associated in the phonebook database 86a.

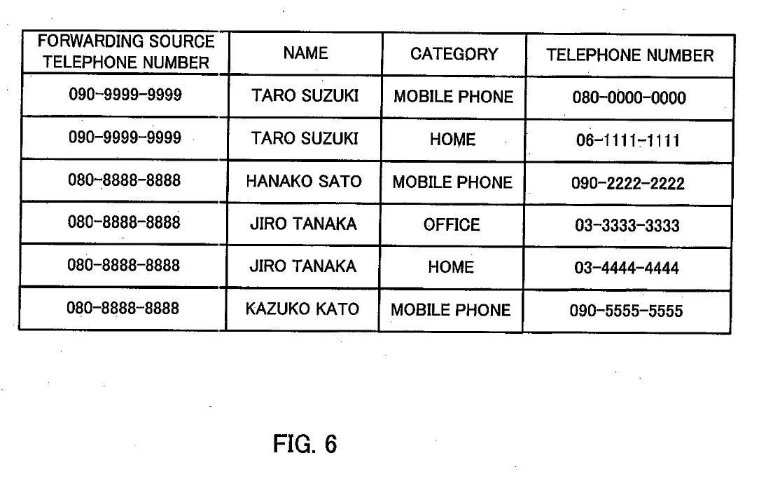

FIG. 6 is an example of phonebook data stored in the phonebook database 86a. When storing phonebook data in the phonebook database 86a, they are stored in a condition such that they can be distinguished from phonebook data forwarded from another mobile phone. Although they are shown in a table format in FIG. 6, the phonebook data and forwarding source telephone number not being limited to being stored in a table format, it is sufficient that the forwarding source telephone number can be referenced from the phonebook data. Also, in FIG. 6, a name, category, and telephone number are shown as the phonebook data, but it is also acceptable that other information, such as an e-mail address or a residence address, is included. Also, with the phonebook data shown in FIG. 6, a case wherein phonebook data having differing telephone numbers, such as “080-0000-0000” or “090-5555-5555”, are stored associated with a forwarding source telephone number “090-9999-9999” or “080-8888-8888” is given as an example, but it is also conceivable that phonebook data having the same telephone number are forwarded individually from differing mobile phones. For example, it may happen that phonebook data having the telephone number “080-0000-0000” are not only forwarded from the mobile phone with the telephone number “090-9999-9999”, but are also forwarded from the mobile phone with the telephone number “080-8888-8888”. In this kind of case, too, the forwarded phonebook data are stored associated with each forwarding source telephone number.

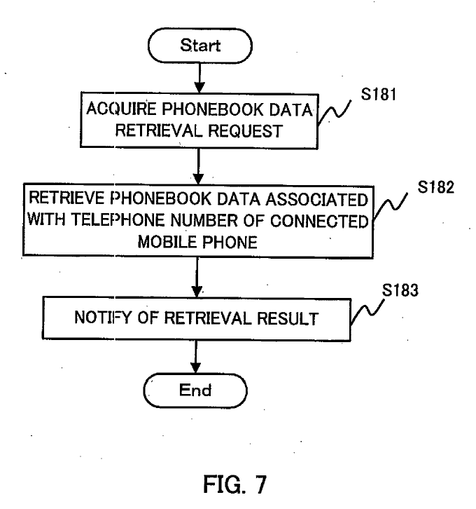

FIG. 7 is a flowchart showing a process when the phonebook access control section 89 carries out a retrieval of data from the phonebook data registered in the phonebook database 86a. Firstly, the phonebook access control section 89 acquires a request to retrieve the phonebook data from an upper layer application executed by the controller 81 (S181). A case of receiving a phonebook data retrieval request from an upper layer application is, for example, a kind of case wherein, when an incoming voice call is received by the hands-free control section 88, an upper layer application of the controller 81 makes a request to the phonebook access control section 89 for the name data stored in the phonebook database 86a associated with the telephone number of the incoming voice call.

The phonebook access control section 89 which receives the phonebook data retrieval request acquires the telephone number of the mobile phone number 1 whose connection has been established by the hands-free control section 88. Then, the phonebook access control section 89 carries out a retrieval, in accordance with the request from the upper layer application, from among the phonebook data stored in the phonebook database 86a associated with the telephone number of the connected mobile phone 1 (S182). Then, the phonebook access control section 89 notifies the upper layer application of a retrieval result (S183).

In this way, the phonebook access control section 89 which receives the phonebook data retrieval request output data, among the phonebook data stored in the phonebook database 86a, associated with the telephone number of the mobile phone 1 in hands-free connection. Therefore it can be prevented to output inappropriate phonebook data from the display section 83 and voice input-output section 84 of the car kit 2.

Even in the event that phonebook data having the same telephone number are registered associated with each telephone number of differing forwarding sources, it is possible to retrieve the phonebook data associated with the forwarding source telephone number. Since the owner of the forwarding source mobile phone can register a data such as the name associated with the telephone number, it may happen that, even though same telephone numbers are registered in the phonebook database 86a, the data such as the name associated with each telephone numbers are different. In this kind of case, the phonebook access control section 89, when retrieving the phonebook database 86a with the telephone number as a key, retrieves the phonebook data which meet the retrieval conditions from the phonebook data associated with the telephone number off the mobile phone in hands-free connection, and responds to the upper layer application, meaning that it is possible to prevent from responding with phonebook data associated with the telephone number of the mobile phone not in hands-free connection.

Although, in the flowchart of FIG. 7, a case is illustrated wherein the phonebook access control section 89, by eliminating the phonebook data not associated with the telephone number of the mobile phone in hands-free connection from the retrieval range, to prevent the phonebook data not associated with the telephone number of the connected mobile phone from being output from the phonebook access control section 89, not being limited to this. It is sufficient that the phonebook data not associated with the telephone number of the connected mobile phone are not included in the retrieval result of which the upper layer application is notified. For example, it is acceptable to retrieve data which match the retrieval conditions from the phonebook database 86a, and notify the upper layer application of only the phonebook data, from among those data, associated with the telephone number of the connected mobile phone as the retrieval result.

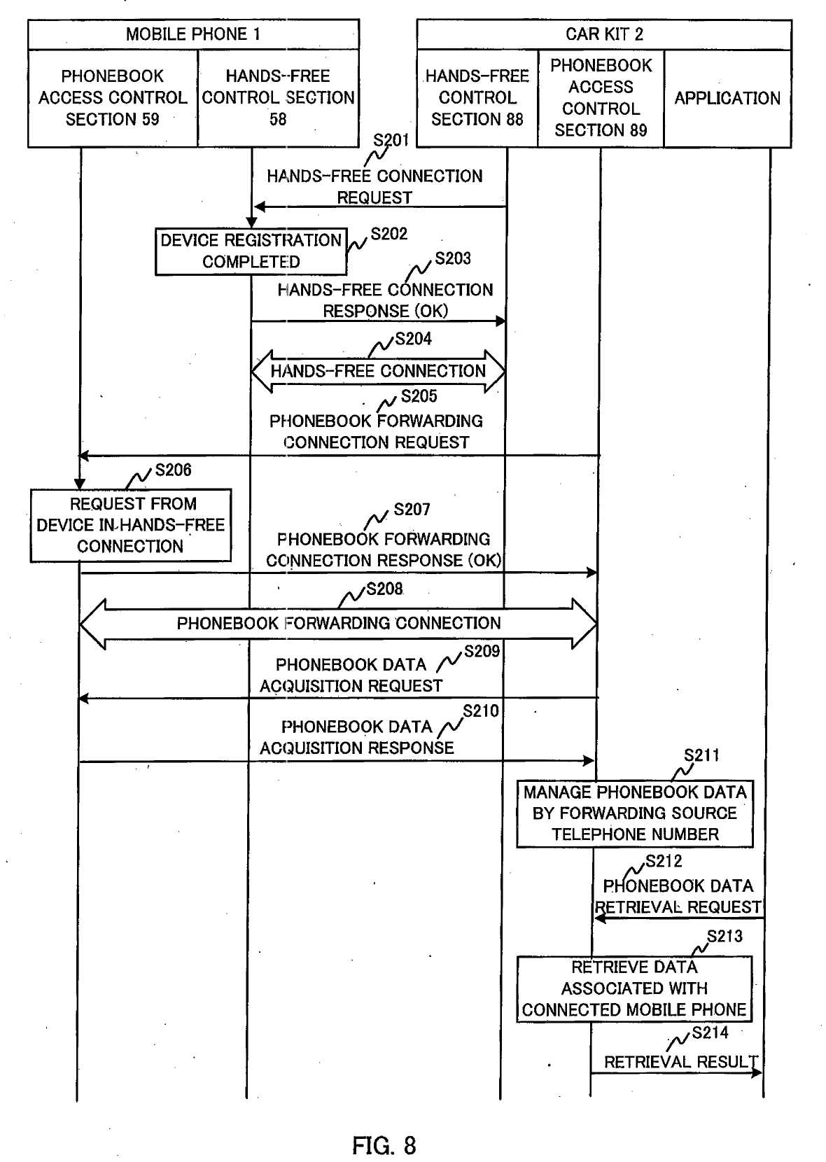

FIG. 8 is a sequence diagram showing a flow of a process when phonebook forwarding is carried out between the mobile phone 1 and car kit 2, and an upper layer application of the car kit 2 issues a request to retrieve the forwarded phonebook data.

On a predetermined operation requesting a hands-free connection of the mobile phone 1 and car kit 2 being input by the user into the car kit 2, via the operating section 82, the hands-free control section 88 of the car kit 2 outputs a hands-free connection request to the hands-free control section 58 of the mobile phone 1 (S201). The hands-free control section 58 of the mobile phone 1, when receiving the hands-free connection request, confirms whether or not the hands-free device registration is completed for the device which has output the hands-free connection request (S202). Then, in the event that it can confirm that the device registration is completed, the hands-free control section 58 outputs a response indicating that the hands-free connection is possible (S203). Then, the hands-free connection is established by the hands-free control section 58 and hands-free control section 88 (S204).

Subsequently, the phonebook access control section 89 of the car kit 2 transmits a phonebook forwarding connection request to the phonebook access control section 59 of the mobile phone 1 (S205). The phonebook access control section 59 of the mobile phone 1, using information included in the received phonebook forwarding connection request identifying the car kit 2, confirms whether or not it is a phonebook forwarding connection request from a device in a hands-free connection (S206). Then, in the event that it is a phonebook forwarding connection request from a device in a hands-free connection, the phonebook access control section 59 transmits a response to the phonebook access control section 89 of the car kit 2 indicating that a connection is possible (S207), and the phonebook forwarding connection is started (S208). In the event that, after the phonebook forwarding connection is established, the phonebook access control section 59 of the mobile phone 1 receives a phonebook data acquisition request from the phonebook access control section 89 of the car kit 2 (S209), the phonebook access control section 59 forwards the phonebook data registered in the phonebook database 56a to the phonebook access control section 89 of the car kit 2 (S210).

The phonebook access control section 89 of the car kit stores the phonebook data acquired in response to the phonebook data acquisition request in the phonebook database 86a, associated with the telephone number of the mobile phone which is the phonebook data forwarding source (S211).

Then, on the phonebook access control section 89 receiving a phonebook data retrieval request from an upper layer application operated by the controller 81 (S212), the phonebook access control section 89 acquires the telephone number of the mobile phone connected by the hands-free control section 88 when receiving the phonebook forwarding request, and retrieves the phonebook data stored in the phonebook database 56a associated with the telephone number of the connected mobile phone (S213). Then, the phonebook access control section 89 transmits the retrieval result obtained to the upper layer application operated by the controller 81 (S214).

In the way heretofore described, when an car kit which receives a forwarding of phonebook data stores the phonebook data, it stores them associated with identification information identifying the device which is the phonebook data forwarding source and, in the event of receiving a request from an upper layer application to retrieve the phonebook data, it carries out a retrieval from the phonebook data stored associated with identification information of a device currently in a hands-free connection. By adopting this kind of embodiment configuration, it being possible to carry out retrieval from the phonebook data associated with the connected device, it does not happen that the phonebook data are output when a device other than the device which is the forwarding source is connected, and it is possible to preserve information security.

The heretofore described embodiment not being limiting, it is acceptable to change appropriately, without departing from the scope of the invention. For example, in the embodiment, a description is given with an car kit and mobile phone as examples but, not being limited to these, it is sufficient that a phonebook forwarding source device and phonebook forwarding destination device include a hands-free function and a phonebook forwarding function.

According to an embodiment of the invention, it is possible to provide a hands-free device which, when receiving a forwarding of phonebook data, can protect personal information in the phonebook data.

What is claimed is:

1. A hands-free device, comprising:
a radio interface configured to communicate with an external device via a short-range wireless communication;
a hands-free control unit configured to control hands-free connection with an external device by using the radio interface;
a phonebook access control unit configured to obtain phonebook data from an external device by using the radio interface;
a memory configured to store the phonebook data associated with an identification information of the external device which forwarded the phonebook data; and
a controller configured to retrieve stored phonebook data which is associated with identification information of the external device to which the hands-free control unit is connecting.

2. The hands-free device according to claim 1, wherein the controller retrieves phonebook data if the hands-free control unit receives an incoming call via the external device which is connected by the hands-free control unit.

3. The hands-free device according to claim 1, wherein the identification information of the external device is a telephone number.

4. The hands-free device according to claim 1, further comprising:
a display configured to display the retrieved phonebook data.

5. The hands-free device according to claim 1, wherein the phonebook access control unit obtains the phonebook data from the external device which is established the hands-free connection.

6. A hands-free device, comprising:
a radio interface configured to communicate with an external device via a short-range wireless communication;
a hands-free control unit configured to control hands-free connection with an external device by using the radio interface;
a phonebook access control unit configured to obtain phonebook data from an external device by using the radio interface;
a memory configured to store phonebook data obtained by the phonebook access control unit; and
a controller configured to retrieve stored phonebook data obtained from an external device to which the hands-free control unit is connecting.

7. The hands-free device according to claim 6, wherein the controller retrieves a phonebook data if the hands-free control unit receives incoming call from the external device currently connected.

8. The hands-free device according to claim 6, further comprising:
a display configured to display the retrieved phonebook data.

9. The hands-free device according to claim 6, wherein the phonebook access control unit obtains the phonebook data from the external device to which the hands-free control unit establishes the hands-free connection.

10. A hands-free device, comprising:
a radio interface configured to communicate with an external device via a short-range wireless communication;
means for controlling hands-free connection with an external device by using the radio interface;
means for obtaining phonebook data from an external device by using the radio interface;
means for storing phonebook data obtained by the phonebook access control unit; and
means for retrieving a stored phonebook data obtained from an external device to which the hands-free control unit currently connected when a retrieving request is received from an upper layer application.

11. A hands-free device according to claim 10, wherein retrieving request is generated by the upper layer application if incoming call is received from a connected external device.

12. A hands-free device according to claim 10, wherein the identification information of an external device is telephone number.

13. A hands-free device according to claim 10, further comprising:
means for outputting the retrieved phonebook data.

14. A hands-free device according to claim 10, wherein the phonebook data is obtained from a hands-free connected external device.

15. A hands-free device comprising:
a radio interface configured to communicate with an external device via a short-range wireless communication;
a memory configured to store phonebook data composed of at least one phonebook data item;
a session control unit configured to establish a first session for making a hands-free communication via an external device connected to the radio interface and a second session for obtaining phonebook data from an external device connected to the radio interface; and
a controller configured to search a phonebook item in which identification information, corresponding to identification information of an external device which is connecting to the hands-free device via the radio interface, is included.
